(19) United States
(12) Patent Application Publication
(10) Pub. No.: US 2011/0134182 A1
(43) Pub. Date: Jun. 9, 2011

(54) INKJET HEAD PACKAGE

(75) Inventors: Ju Hwan Yang, Suwon (KR); Jae Woo Joung, Suwon (KR); Young Seuck Yoo, Seoul (KR); Jae Hun Kim, Seoul (KR); Yun Sung Kang, Suwon (KR)

(73) Assignee: SAMSUNG ELECTRO-MECHANICS CO., LTD., Suwon (KR)

(21) Appl. No.: 12/903,094

(22) Filed: Oct. 12, 2010

(30) Foreign Application Priority Data
Dec. 4, 2009 (KR) 10-2009-0119608

(51) Int. Cl. B41J 2/015

(52) U.S. Cl. 347/20

(57) ABSTRACT

There is provided an inkjet head package including: an ink head having an actuator mounted thereon and ejecting ink to the outside by a driving force of the actuator; an intermediate substrate disposed between the ink head and an ink storage supplying ink to the ink head, and having a socket provided on a surface thereof; and a lead frame provided on an upper surface of the ink head such that the intermediate substrate and the actuator are electrically connected to each other.

### CROSS-REFERENCE TO RELATED APPLICATIONS

This application claims the priority of Korean Patent Application No. 10-2009-0119608 filed on Dec. 4, 2009 in the Korean Intellectual Property Office, the disclosure of which is incorporated herein by reference.

### BACKGROUND OF THE INVENTION

1. Field of the Invention

The present invention relates to an inkjet head package, and more particularly, to a method of fabricating an inkjet head package facilitating a supply of ink into an ink chamber.

2. Description of the Related Art

An inkjet head package generally converts electrical signals into physical impulses so that ink droplets are ejected through small nozzles.

In recent years, a piezoelectric inkjet head package has been used in industrial inkjet printers. For example, the piezoelectric inkjet head package is used to directly form a circuit pattern by spraying ink prepared by melting metals such as gold and silver onto a printed circuit board (PCB). The piezoelectric inkjet head package is also used for creating industrial graphics, or for the manufacturing of a liquid crystal display (LCD), an organic light emitting diode (OLED), a solar cell and the like.

In general, an ink head of an inkjet printer includes an inlet and an outlet through which ink is introduced and ejected in a cartridge, a reservoir storing the ink being introduced, and a chamber transferring the driving force of an actuator so as to move the ink stored in the reservoir toward a nozzle.

In this type of inkjet head package, the degree of convenience in the usage of a flexible substrate at the time of the coupling and separation of the ink head and the inkjet printer is directly associated with operational efficiency.

A conventional inkjet printer head has a structure in which an ink head including an actuator is connected to a flexible substrate in a length direction along the entirety of the ink head. This structure is intended to electrically connect the flexible substrate to a connection space of the actuator restricted by the sizes of an adapter and an ink tank.

This flexible substrate is advantageous in a connecting process using an adhesive or a wire. However, since it is necessary to pass through an additional rigid substrate for the connection with a driver, a number of connecting operations are required. Accordingly, there is a need for technologies in order to solve this problem.

### SUMMARY OF THE INVENTION

An aspect of the present invention provides an inkjet head package facilitating an electrical connection.

According to an aspect of the present invention, there is provided an inkjet head package including: an ink head having an actuator mounted thereon and ejecting ink to the outside by a driving force of the actuator; an intermediate substrate disposed between the ink head and an ink storage supplying ink to the ink head, and having a socket provided on a surface thereof; and a lead frame provided on an upper surface of the ink head such that the intermediate substrate and the actuator are electrically connected to each other.

The lead frame may be connected to a side surface of the intermediate substrate.

The lead frame may include a horizontal portion in contact with the upper surface of the ink head, and a vertical portion in contact with the side surface of the intermediate substrate by being bent at an end of the horizontal portion.

The intermediate substrate and the ink head may have the same width.

The intermediate substrate may have a substrate recess in order to receive the actuator therein.

The inkjet head package may further include a damper disposed between the intermediate substrate and the ink head and absorbing vibrations from the actuator.

The damper may have a damper recess in order to receive the actuator therein.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an inkjet head package according to an exemplary embodiment of the present invention;

FIG. 2 is an exploded perspective view illustrating the inkjet head package of FIG. 1;

FIG. 3 is a perspective view illustrating an intermediate substrate of an inkjet head package according to an exemplary embodiment of the present invention;

FIG. 4 is an exploded perspective view illustrating an inkjet head package according to another exemplary embodiment of the present invention;

FIG. 5 is a schematic cross-sectional view illustrating the effect of a damper in an inkjet head package according to another exemplary embodiment of the present invention; and

FIG. 6 is a perspective view illustrating a rear surface of the damper in the inkjet head package of FIG. 5.

### DETAILED DESCRIPTION OF THE PREFERRED EMBODIMENT

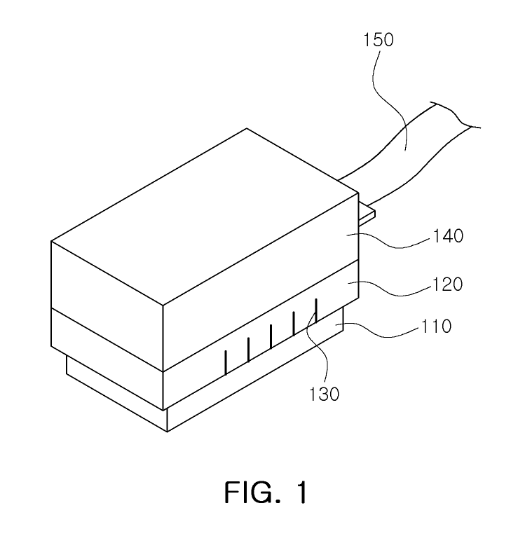

An inkjet head package according to exemplary embodiments of the present invention will be described with reference to FIGS. 1 through 6. Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to refer to the same or like parts.

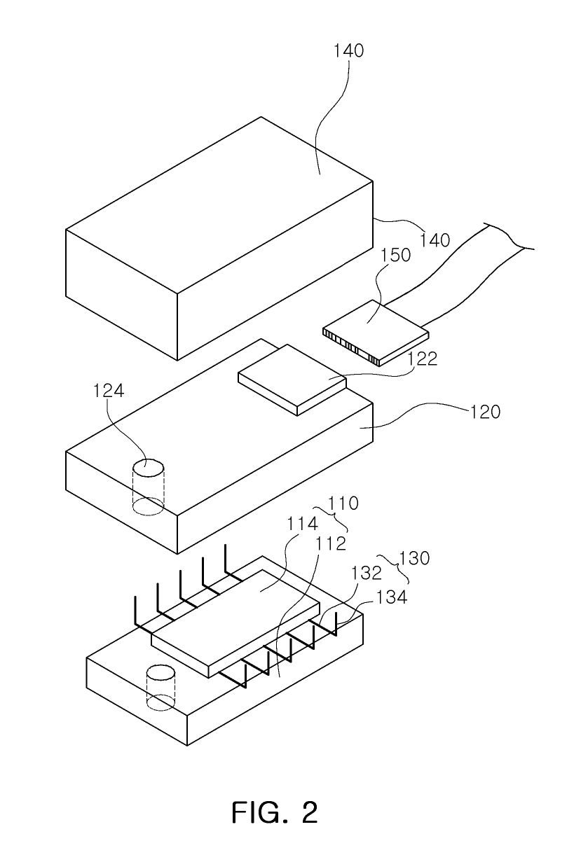

FIG. 1 is a schematic perspective view illustrating an inkjet head package according to an exemplary embodiment of the present invention. FIG. 2 is an exploded perspective view illustrating the inkjet head package of FIG. 1.

Referring to FIGS. 1 and 2, an inkjet head package may include an ink head 110, an intermediate substrate 120, and a lead frame 130.

The ink head 110 includes a body 112 made of a multilayer silicon substrate. Inside the body 112, a flow path of an ink chamber, a nozzle, a reservoir and the like may be formed.

Here, the ink chamber stores ink injected from the outside and the nozzle is a hole ejecting the ink to the outside. The reservoir is a storage space where ink is stored in order to supply the ink to the ink chamber.

However, the material of the ink head 110 is not limited thereto. The structure of the ink head 110 may also be a multilayer structure or a monolayer structure.

Also, an actuator 114 is formed on the body 112. The actuator 114 may have electrodes electrically connected to the upper and lower surfaces thereof. The actuator 114 may be formed of Lead Zirconate Titanate (PZT) ceramics, which is one of a range of piezoelectric materials.

The side surface of the actuator 114 may be electrically connected to the lead frame 130. The actuator 114 may be mounted above the ink chamber.

Here, a vibration plate may be prepared between the actuator 114 and the ink chamber. The vibrations of the actuator 114 change the volumes of the ink chamber through the vibration plate. The volumes of the ink chamber are changed to increase the pressure inside the ink chamber, so that ink inside the ink chamber is ejected to the outside through a damper and the nozzle.

The intermediate substrate 120 is disposed between the ink head 110 and an ink storage 140 and is electrically connected to the lead frame 130 in contact with the side surface of the intermediate substrate 120. Here, the lead frame 130 and the intermediate substrate 120 are electrically connected to each other by soldering.

The intermediate substrate 120 may be shaped to have the same size as the ink storage 140, thereby forming a single package shape.

Also, the intermediate substrate 120 may have an ink injection hole 124 transferring ink stored in the ink storage 140 to the ink head 110.

Further, the intermediate substrate 120 may have a socket 122 formed on a surface thereof. The socket 122 may be electrically connected to an external driver 150.

A conventional inkjet head package uses a flexible substrate, so it requires a connection of a separate rigid substrate, whereby it has a disadvantage in an assembly process. However, the ink head package including the intermediate substrate 120 is fabricated to have a simple structure for facilitating its electrical connection, and thus the assembly process thereof can be simplified.

The lead frame 130 may be formed on the upper surface of the ink head 110 such that the intermediate substrate 120 and the actuator 114 are electrically connected to each other.

Here, the lead frame 130 may include a horizontal portion 132 in contact with the upper surface of the ink head 110 and a vertical portion 134 in contact with the side surface of the intermediate substrate 120 by being bent at the end of the horizontal portion 132. Therefore, an L-shaped lead frame may be formed. However, the shape of the lead frame 130 is not limited thereto, and may be varied according to a designer's intention.

The end of the vertical portion 134 may be electrically connected to the side surface of the intermediate substrate 120. As described above, the electrical connection may be made by soldering.

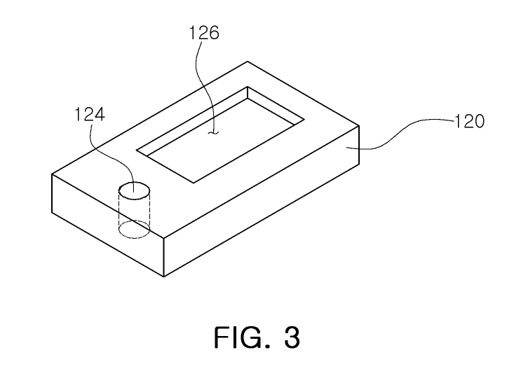

FIG. 3 is a perspective view illustrating an intermediate substrate of an inkjet head package according to an exemplary embodiment of the present invention.

Referring to FIG. 3, the intermediate substrate 120 may have a substrate recess 126 formed in the bottom surface thereof to correspond to the size of the actuator 114. Therefore, a space capable of receiving the vibrations of the actuator 114 may be prepared by the substrate recess 126.

Therefore, the lead frame 130 may be assembled such that the intermediate substrate 120 and the ink head 110 contact each other by receiving the actuator 114 in the substrate recess 126. Since the lead frame 130 is fixed to the side surface of the intermediate substrate 120, the ink injection hole 124, the intermediate substrate 120 and the ink head 110 may be fabricated as a single package.

Accordingly, the inkjet head package according to this embodiment of the invention facilitates its own storage and movement, as compared with earlier models.

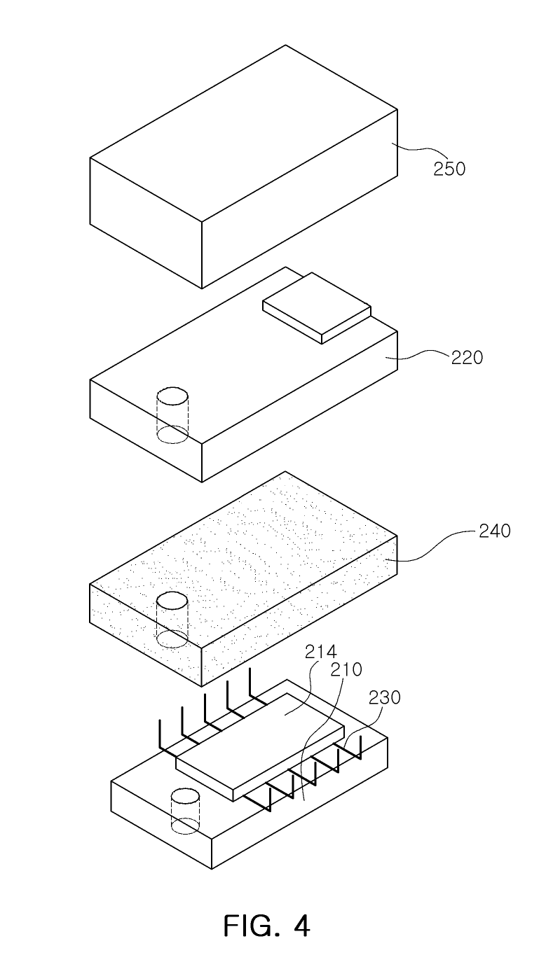

FIG. 4 is an exploded perspective view illustrating an inkjet head package according to another exemplary embodiment of the present invention.

Referring to FIG. 4, an inkjet head package may include an ink head 210, an intermediate substrate 220, a lead frame 230, and a damper 240.

The ink head 210, the intermediate substrate 220 and the lead frame 230 according to this embodiment are substantially the same as those of the aforementioned embodiment, so a detailed description thereof will be omitted.

The damper 240 may be disposed between the intermediate substrate 220 and the ink head 210. The damper 240 may be formed of rubber.

The damper 240 may have the same shape as the intermediate substrate 220 and an ink storage 250. The damper 240 may include a hole corresponding to an ink injection hole of the intermediate substrate 220.

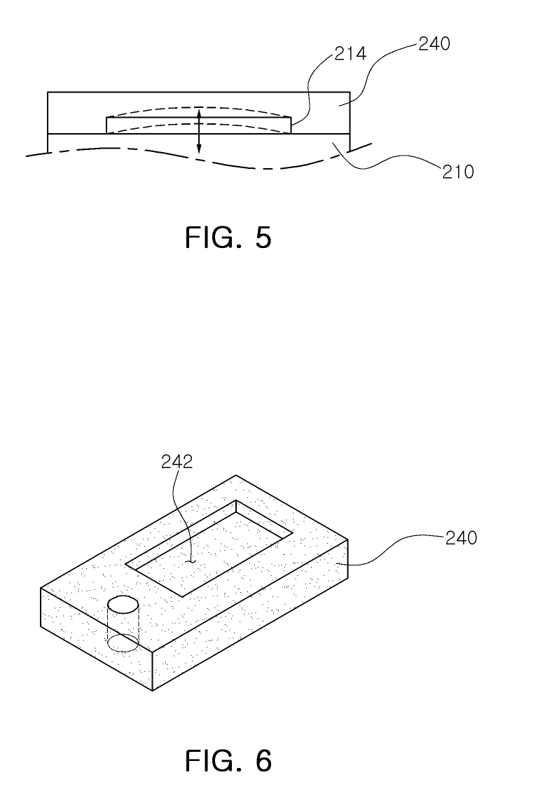

FIG. 5 is a schematic cross-sectional view illustrating the effect of a damper in an inkjet head package according to another exemplary embodiment of the present invention. FIG. 6 is a perspective view illustrating a rear surface of the damper in the inkjet head package of FIG. 5.

Referring to FIG. 5, an actuator 214 is mounted on the upper surface of the ink head 210 and vibrates upwards and downwards. Here, the damper 240 is deformed to correspond to the above vibrations of the actuator 214.

The damper 240 does not allow the above vibrations to be transferred to the intermediate substrate 220, and thus a more stable structure may be obtained.

Referring to FIG. 6, a damper recess 242 may be provided to be corresponded to the actuator 214 on the rear surface of the damper 240. Therefore, the damper 240 and the ink head 210 may be assembled in such a manner that the actuator 214 is received in the damper recess 242.

In this embodiment, the lead frame 230 is fixed to the side surface of the intermediate substrate 220 and the ink storage 250, the intermediate substrate 220, the damper 240 and the ink head 210 may be fabricated as a single package. Therefore, the inkjet head package according to this embodiment of the invention facilitates its own storage and movement as compared with the earlier models.

As set forth above, according to exemplary embodiments of the invention, since the inkjet head package includes the lead frame formed on the upper surface of the ink head such that the intermediate substrate and the actuator are electrically connected to each other, the inkjet head package is fabricated as a single package, thereby facilitating its own storage and movement as compared with earlier models.

Also, since the intermediate substrate includes a socket on a surface thereof, a structure for electrical connection may be simply constructed. Accordingly, assembly process may be simplified.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head package comprising:
an ink head having an actuator mounted thereon and ejecting ink to the outside by a driving force of the actuator;
an intermediate substrate disposed between the ink head and an ink storage supplying ink to the ink head, and having a socket provided on a surface thereof; and
a lead frame provided on an upper surface of the ink head such that the intermediate substrate and the actuator are electrically connected to each other.

2. The inkjet head package of claim 1, wherein the lead frame is connected to a side surface of the intermediate substrate.

3. The inkjet head package of claim 1, wherein the lead frame comprises:
a horizontal portion in contact with the upper surface of the ink head; and
a vertical portion in contact with the side surface of the intermediate substrate by being bent at an end of the horizontal portion.

4. The inkjet head package of claim 1, wherein the intermediate substrate and the ink head have the same width.

5. The inkjet head package of claim 1, wherein the intermediate substrate has a substrate recess in order to receive the actuator therein.

6. The inkjet head package of claim 1, further comprising a damper disposed between the intermediate substrate and the ink head and absorbing vibrations from the actuator.

7. The inkjet head package of claim 6, wherein the damper has a damper recess in order to receive the actuator therein.
